(19) United States
(12) Patent Application Publication
(10) Pub. No.: US 2008/0120983 A1
(43) Pub. Date: May 29, 2008

(54) SYSTEM AND PROCESS FOR REHEATING SEAWATER AS USED WITH LNG VAPORIZATION

(76) Inventor: Dirk EYERMANN, Ettlingen (DE)

Correspondence Address: EGBERT LAW OFFICES, 412 MAIN STREET, 7TH FLOOR, HOUSTON, TX, 77002, US

(21) Appl. No.: 11/556,692

(22) Filed: Nov. 4, 2006

Related U.S. Application Data
(60) Provisional application No. 60/795,747, filed on Apr. 28, 2006.

(51) Int. Cl. F17C 9/02

(52) U.S. Cl. 62/50.2

(57) ABSTRACT

A system for vaporization of liquefied natural gas has a first heat exchange having a first fluid line in heat exchange relationship with a second fluid line, a pump connected to an inlet of the first fluid line for passing seawater through the first fluid line, and a second heat exchanger connected to an outlet of the first fluid line for warming the cooled seawater from the first heat exchanger by heat exchange with air. The second fluid line is suitable for passing the liquefied natural gas through the first heat exchanger. The second heat exchanger has an outlet for discharging the warmed seawater through a flow line connected to an inlet of the first fluid line of the first heat exchanger.

### CROSS-REFERENCE TO RELATED U.S. APPLICATIONS

The present application claims priority from U.S. Provisional Application Ser. No. 60/795,747, filed on Apr. 25, 2006, and entitled “System and Process for Reheating Seawater as Used for LNG Vaporization”.

### STATEMENT REGARDING FEDERALLY SPONSORED RESEARCH OR DEVELOPMENT

Not applicable.

### NAMES OF PARTIES TO A JOINT RESEARCH AGREEMENT

Not applicable.

### REFERENCE TO AN APPENDIX SUBMITTED ON COMPACT DISC

Not applicable.

### BACKGROUND OF THE INVENTION

1. Field of the Invention

The present invention relates to systems and processes for vaporizing liquefied natural gas. More particularly, the present invention relates to systems and processes whereby the cooled seawater used for LNG vaporization can be reheated. Additionally, the present invention relates to processes and systems whereby liquefied natural gas is vaporized by heat exchange action imparted onto a circulated fluid by ambient seawater.

2. Description of Related Art Including Information Disclosed Under 37 CFR 1.97 and 37 CFR 1.98.

An increasingly common technique for transporting natural gas over large distances is to liquify the natural gas. This liquefied natural gas can then be made available for easier transportation by means of a vessel, such as a ship or a truck. At the destination, commonly known as a LNG receiving terminal, the LNG is returned to its gaseous state. There are two commonly employed techniques for the vaporization of the LNG. One technique is to use a submerged combustion vaporizer and the other technique is the use of an open rack vaporizer.

Evaporators of the submerged combustion-type comprise a water bath in which the fuel gas tube of a gas burner is installed, as well as the exchanger tube bundle for the vaporization of the liquefied natural gas. The gas burner discharges the combustion flue gases into the water bath, which heat the water and provide the heat for the vaporization for the liquefied natural gas. The liquefied natural gas flows through the tube bundle. Evaporators of this type are reliable and of compact size, but they involve the use of fuel gas and, thus, are very expensive to operate.

Open rack-type evaporators use seawater as a heat source for the vaporization of the liquefied natural gas. These evaporators use once-through seawater flow on the outside of a heat exchanger as the source of heat for the vaporization. They do not block from freezing water, are easy to operate and maintain, but they are very expensive to build. These open rack-type evaporators are widely used in Japan. Their use in the U.S. and in Europe is limited and economically difficult to justify for several reasons. First, the present permitting environment does not allow returning the seawater to the sea at a very cold temperature because of environmental concerns for marine life. The present permitting environment allows only a small decrease in temperature before returning the seawater back to the sea. This requires a very large quantity of seawater to be pumped through the system if the terminal vaporization was designed for a commercial size as the economics would require. Also, coastal waters, such as those in the southern United States, are often not clean and contain a substantial quantity of suspended solids. This requires filtration. In addition, the seawater intake structure has to be located far away from the evaporators, in most cases, because of location restraints and in order to get to the deep clean seawater at the intake. The LNG receiving terminal, used in an open rack-type vaporizer will consume between 20 and 50 million gallons of seawater per day. Marine life does not survive the high pressure flow through the open rack-type vaporizers. This is especially the case when chemicals, such as hypochlorite, is added to the seawater. These chemicals are often added to the seawater in order to prevent bio-fouling. Additionally, these chemicals are often added in order to kill the marine life within the tubing. This can cause damage to the nearby marine life, especially in the case in which small fish consume of plankton.

Evaporators of an intermediate fluid-type utilize a refrigerant, such as freon or propane, having a low temperature of solidification, to transfer the heat from a warm water stream to the liquefied natural gas. This is achieved by heating the liquid refrigerant in a reboiler-type exchanger with ambient once-through water in the tube bundle. The refrigerant vaporizes, condenses to liquid on the cold liquefied natural gas exchangers tubes located in the vapor space of the exchanger, and falls back into the liquefied refrigerant bath, where it is again vaporized. The heat of condensation of the refrigerant provides the heat of vaporization of the liquefied natural gas. These types of vaporizers are less expensive to build, but they have the same permitting restraints as the open rack-type evaporators.

U.S. Pat. No. 6,622,492, issued on Sep. 23, 2003 to V. Eyermann, describes an apparatus and process for vaporizing liquefied natural gas including the extraction of heat from ambient air to heat circulating water. The heat exchange process includes a heat exchanger for the vaporization of liquefied natural gas, a circulating water system, and a water tower that extracts heat from the ambient air in order to heat the circulating water. A submerged fired heater is connected to the water tower basin so as to allow the process to work throughout the year by supplementing the heat to the system.

U.S. Pat. No. 6,644,041, issued on Nov. 11, 2003 to V. Eyermann, describes another process for vaporizing liquefied natural. The process includes the steps of passing water into a water tower so as to elevate a temperature of the water, pumping the elevated temperature water through a first heat exchanger, passing a circulating fluid through the first heat exchanger so as to transfer heat from the elevated temperature water into the circulating fluid, passing the liquefied natural gas into a second heat exchanger, pumping the heated circulating fluid from the first heat exchanger into the second heat exchanger so as to transfer heat from the circulating fluid to the liquefied natural gas, and discharging vaporized natural gas from the second heat exchanger.

It is an object of the present invention to minimize the environmental impact of open rack-type vaporizers.

It is another object of the present invention to provide a system for the vaporization of liquefied natural gas that facilitates the ability to obtain official approval for such open rack-type vaporizers.

It is another object of the present invention to provide a system and process that enables existing LNG-receiving terminals to upgrade existing open rack-type vaporizers should higher governmental standards in the future arise.

It is a further object of the present invention to provide a system and process for the vaporization of liquefied natural gas which reduces the consumption of fresh seawater by adding ambient air as an additional heating source throughout the year.

It is a further object of the present invention to provide a system and process for the vaporization of liquefied natural gas which allows the open rack-type vaporizers to operate with a higher temperature delta.

It is also a further object of the present invention to provide a system and process for the vaporization of liquefied natural gas wherein additional seawater may not need to be consumed at all during certain portions of the year.

It is a further object of the present invention to provide a system, when ambient seawater temperature is under 8° C. under certain weather conditions, that will run an open rack-type vaporizer using elevated inflowing temperature seawater.

These and other objects and advantages of the present invention will become apparent from a reading of the attached specification and appended claims.

### BRIEF SUMMARY OF THE INVENTION

The present invention is a system for the vaporization of liquefied natural gas that comprises a first heat exchanger having a first fluid line in heat exchange relationship with a second fluid line, a pump connected to an inlet of the first fluid line for passing seawater through the first fluid line in heat exchange relationship with liquefied natural gas passing through the second fluid line of the first heat exchanger, and a second heat exchanger connected to an outlet of the first fluid line. The second heat exchanger warms the cooled seawater from the first heat exchanger by heat exchange relationship with air. The second heat exchanger has an outlet suitable for discharging the warmed seawater from the second heat exchanger. The first heat exchanger exchanges heat from the seawater and the first fluid line to the liquefied natural gas in the second fluid line so as to produce vaporized liquefied natural gas and cooled seawater.

A flow line is connected to the outlet of the second heat exchanger and is interconnected to the inlet of the first fluid line of the first heat exchanger. This flow line is suitable for passing the warmed seawater to the first heat exchanger. In the preferred embodiment of the present invention, the first heat exchanger is an open-rack vaporizer. Also, in the preferred embodiment of the present invention, the second heat exchanger is a water tower.

When a water tower is used as a second heat exchanger, the water tower has a surface over which the cooled seawater cascades such that the cooled seawater contacts ambient air. A fan can be placed on the water tower suitable for forcing ambient air toward the surface of the water tower. A collector is formed at the bottom of the water tower so as to receive condensate therein. The outlet of the second heat exchanger passes the condensate and the warmed seawater therefrom. The outlet of the second heat exchanger is connected to a body of water such that the discharged warmed seawater can pass into the body of water.

The present invention can also include a saltwater analyzer cooperative with the warmed seawater passing to the inlet of the first fluid line of the first heat exchanger for analyzing a salt content of the warmed seawater passing to the first heat exchanger. The present invention can also include a burner or other heat generator that is cooperative with the seawater passing to the inlet of the first fluid line of the first heat exchanger so as to elevate a temperature of the seawater separate from the second heat exchanger.

In alternative embodiment of the present invention, the second heat exchanger can be a shell-and-tube heat exchanger or a plate-type heat exchanger.

The present invention is also a process for vaporizing liquefied natural gas that comprises the steps of: (1) flowing seawater through a first heat exchanger; (2) passing liquefied natural gas in heat exchange relationship with the seawater flowing through the first heat exchanger so as to produce vaporized liquefied natural gas and cooled seawater; (3) discharging the vaporized liquefied natural gas from the first heat exchanger; (4) passing the cooled seawater to a second heat exchanger; and (5) warming the cooled seawater by interaction with air in the second heat exchanger.

In this process, at least a portion of the warmed seawater is introduced into the flow of seawater to the first heat exchanger. Another portion of the warmed seawater can be discharged into a body of water.

The step of flowing seawater includes pumping seawater from the body of water to an inlet of the first heat exchanger.

When the second heat exchanger is a water tower, the step of warming includes cascading the cooled seawater over a surface of the water tower so as to interact the cooled seawater with ambient air so as to elevate a temperature of the cooled seawater. This step of warming also includes forcing the ambient air onto the cascading cooled seawater. Condensate can be collected from the interaction of cooled seawater with ambient air. The warmed seawater and the condensate are discharged into the flow of seawater to the first heat exchanger.

### BRIEF DESCRIPTION OF THE SEVERAL VIEWS OF THE DRAWINGS

FIG. 1 is schematic illustration of the process and system of the present invention.

### DETAILED DESCRIPTION OF THE INVENTION

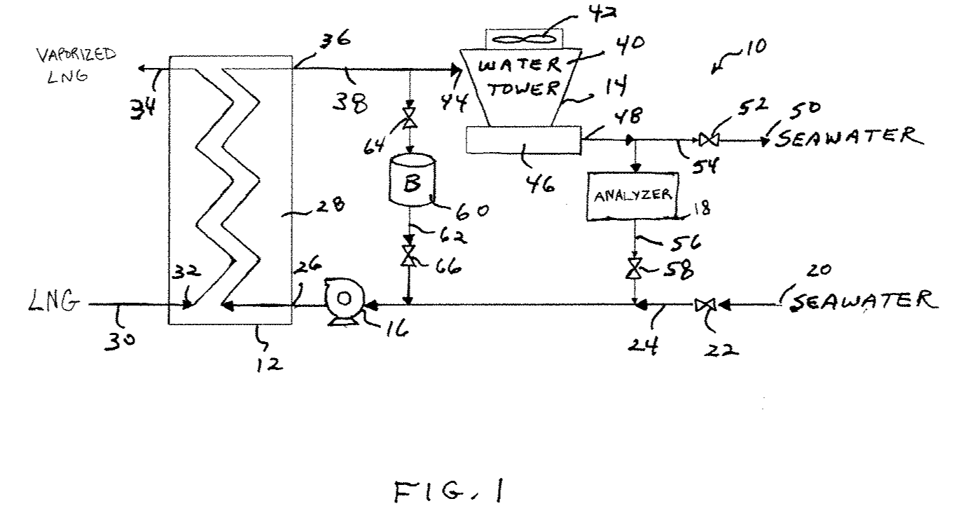

Referring to FIG. 1, there is shown the process and system 10 of the present invention for the vaporizing of liquefied natural gas and for the reheating of seawater passing from the vaporization heat exchanger. The process 10 of the present invention utilizes a first heat exchanger 12, a second heat exchanger 14, and a pump 16.

Initially, in the present invention, a seawater inlet 20 opens to a body of water, such as the ocean. A suitable valve 22 is connected along line 24 so as to control the rate at which the seawater enters the inlet 20. The seawater passing into inlet 20 is pumped by pump 16 toward the first heat exchanger 12 along line 24. The seawater will flow at high pressure into the inlet 26 of the open rack-type vaporizer 28 that is used as the first heat exchanger 12. Liquefied natural gas passes through line 30 to the inlet 32 of the open rack-type vaporizer 28 of first heat exchanger 12. In particular, the liquefied natural gas will enter the open rack-type vaporizer 28 at a temperature of under −243.3 F.

Within the interior of the open rack-type vaporizer 28, the warm seawater will pass in heat exchange relationship with the liquefied natural gas so as to elevate the temperature of the liquefied natural gas. As a result, vaporized liquefied natural gas will exit from the open rack-type vaporizer 28 through outlet 34 in a gaseous form. Because of the heat-exchange relationship between the liquefied natural gas and the warm seawater, the warmed seawater passing through the open rack-type vaporizer 28 will be substantially cooled. The cooled seawater will leave the open rack-type vaporizer 28 through outlet 36 and along line 38 to the second heat exchanger 14.

The cooled seawater will pass along line 38 to the second heat exchanger 14. The second heat exchanger 14 is a water tower 40 having a fin-type fan 42 mounted thereover. The cooled seawater will enter the water tower 40 through inlet 44. The seawater is then heated by bringing the cold seawater into direct contact with ambient air. While the water flows down a cascade, for example, air is forced through and out of the water tower by using the fan 42. The interaction between the warm air and the cool seawater will elevate the temperature of the seawater. Depending on the weather conditions, more or less air humidity will condensate. This will serve to increase the amount of water flowing out of the water tower 40 and into the collector 46. The seawater mixed with the condensate humidity will leave the water tower from outlet 48. This water mixture is partly delivered back to the ocean through the seawater outlet 50. A valve 52 is placed along the line 54 through the seawater and the condensate mixture passes. Valve 52 can control the flow rate of the seawater and condensate mixture to the outlet 50.

A portion of the heated seawater is passed through a saltwater analyzer 18. This portion of the heated seawater can be reused an delivered back to the open rack-type vaporizer 28. The saltwater analyzer 18 is needed in order to control the discharge temperature at which the open rack-type vaporizer can be run. In other words, one can increase the flow through pump 16 and regulate the out temperature. The higher the salt grade, the lower the out temperature can be. In months where the ambient air is warm enough, it is possible to run the process without having to add additional seawater as a heating source. In this case, only the additional condensate humidity water would have to be drained from the system. As can be seen, this portion of the heated seawater can be passed along line 56 and through valve 58 so as to reenter line 24 for delivery by pump 16 back to the inlet 26 of the first heat exchanger 12.

In very cold months of the year, it is a standard practice to vaporize liquefied natural gas by using submerged combustion vaporizers. As such, the open rack-type vaporizer 28 would not be used. It is also possible to utilize a common boiler 60 connected along line 62 in order to add additional heat to the seawater and to provide enough heat transfer for the liquefied natural gas vaporization process in the open rack-type vaporizer 28. Valves 64 and 66 are provided along lines 62 so as to control the flow rate of the seawater through the boiler 60.

Within concept of the present invention, it is possible to run the process 10 by replacing the open rack-type vaporizer 28 with a shell-and-tube vaporizer. They are usually run in a two loop heat transfer process but can also be used in a single loop process. The water tower 40 can be replaced with a shell-and-tube assembly or a shell-and-tube assembly heat exchanger. Although the ambient air is not in direct contact with the seawater, there are large fans provided so as to circulate the air through the tubes and, hence, create the heat exchange relationship with the cooled seawater. In the present invention, the boiler 20 is not generally necessary. The standard practice can be utilized whereby the submerged combustion vaporizers are utilized to supplement the heat to the vaporization process. The saltwater analyzer 18 may not be necessary. The saltwater analyzer 18 is used depending on how necessary it is to run the process close to the freezing point. The nearer one is the freezing point, the more efficient the process can be run and the longer the process can be run throughout the year. However, it is necessary to be very exact in the control of saltwater concentration.

There can be some weather conditions, wherein the air temperature is much warmer than the seawater. For example, in spring time, the seawater can be too cold for the open rack-type vaporizer 28 to run, but the air temperature is already very warm. In such a case, the process can be reversed in order and run the other way; that is, the seawater is heated first and then run through the open rack-type vaporizer 28. While not very efficient, such a process can be used under certain weather conditions. Additionally, a second water tower may be placed on line 24 so as to elevate the temperature of the seawater before entering the open rack-type vaporizer 28.

The foregoing disclosure and description of the invention is illustrative and explanatory thereof. Various changes in the details of the illustrated system or the described process may be made within the scope of the appended claims without departing from the true spirit of the invention. The present invention should only be limited by the following claims and their legal equivalents.

I claim:

1. A system for vaporization of liquefied natural gas comprising:
a first heat exchange means having a first fluid line in heat exchange relationship with a second fluid line, said first fluid line having an inlet and an outlet, said second fluid line having an inlet and an outlet, said second fluid line suitable for passing the liquefied natural gas through said first heat exchange means, said first heat exchange for exchanging heat from said first fluid line to the liquefied natural gas in said second fluid line so as to produce vaporized liquefied natural gas and cooled seawater;
a pumping means connected to said inlet of said first fluid line of said first heat exchange means for passing seawater through said first fluid line of said first heat exchange means; and
a second heat exchange means connected to said outlet of said first fluid line, said second heat exchange means for warming the cooled seawater from said first heat exchange means by heat exchange with air, said second heat exchange means having an outlet suitable for discharging warmed seawater from said second heat exchange means.

2. The system of claim 1, further comprising:
a flow line connected to said outlet of said second heat exchange means and interconnected to said inlet of said first fluid line of said first heat exchange means, said flow line suitable for passing the warmed seawater to said first heat exchange means.

3. The system of claim 1, said first heat exchange means being an open-rack vaporizer.

4. The system of claim 1, said second heat exchange means comprising a water tower, said water tower having a surface over which the cooled seawater cascades such that the cooled seawater contacts ambient air.

5. The system of claim 4, said water tower having a fan thereon suitable for delivering ambient air toward said surface of said water tower.

6. The system of claim 4, said water tower having a collector at a bottom thereof, said collector receiving condensate therein, said outlet of said second heat exchange means passing the condensate and the warmed seawater therefrom.

7. The system of claim 1, said outlet of said second heat exchange means connected to a body of water such that the discharged warmed seawater passes into the body of water.

8. The system of claim 1, further comprising:
a saltwater analyzer means cooperative with the warmed seawater passing to said inlet of said first fluid line of said first heat exchange means for analyzing a salt content of the warmed seawater passing to said first heat exchange means.

9. The system of claim 1, further comprising:
a burner means cooperative with the seawater passing to the inlet of said first fluid line of said first heat exchange means, said burner means for elevating a temperature of the seawater.

10. The system of claim 1, said second heat exchange means comprising a shell-and-tube heat exchanger.

11. The system of claim 1, said second heat exchange means comprising a plate heat exchanger.

12. A process for vaporizing liquefied natural gas comprising:
flowing seawater through a first heat exchanger;
passing liquefied natural gas in heat exchange relationship with the seawater flowing through said first heat exchanger so as to produced vaporized liquefied natural gas and cooled seawater;
discharging the vaporized liquefied natural gas from said first heat exchanger;
passing the cooled seawater to a second heat exchanger; and
warming the cooled seawater by interaction with air in said second heat exchanger.

13. The process of claim 12, further comprising:
introducing at least a portion of the warmed seawater into the flow of seawater to said first heat exchanger.

14. The process of claim 12, further comprising:
discharging the warmed seawater into a body of water.

15. The process of claim 12, said step of flowing comprising:
pumping seawater from a body of water to an inlet of said first heat exchanger.

16. The process of claim 12, said second heat exchanger being a water tower, said step of warming comprising:
cascading the cooled seawater over a surface of said water tower so as to interact the cooled seawater with ambient air so as to elevate a temperature of the cooled seawater.

17. The process of claim 16, said step of warming further comprising:
forcing the ambient air onto the cascading cooled seawater.

18. The process of claim 17, further comprising:
collecting condensate from the interaction of the cooled seawater with ambient air; and
discharging the warmed seawater and the condensate into the flow of seawater to said first heat exchanger.

19. The process of claim 12, further comprising:
discharging the warmed seawater from said second heat exchanger; and
analyzing a salt content of the discharged warmed seawater.

20. The process of claim 12, further comprising:
applying heat to the cooled seawater by a heat generator separate from said second heat exchanger.
